(19) United States
(12) Patent Application Publication
(10) Pub. No.: US 2015/0106692 A1
(43) Pub. Date: Apr. 16, 2015

(54) DYNAMIC GUIDED TOUR FOR SCREEN READERS

(71) Applicants: Davide Bolchini, Indianapolis, IN (US); Prathik Gadde, Indianapolis, IN (US)

(72) Inventors: Davide Bolchini, Indianapolis, IN (US); Prathik Gadde, Indianapolis, IN (US)

(21) Appl. No.: 14/511,538

(22) Filed: Oct. 10, 2014

Related U.S. Application Data
(60) Provisional application No. 61/889,239, filed on Oct. 10, 2013.

(51) Int. Cl. G06F 17/30; G06F 3/16; G06F 3/0481; G06F 3/0487

(52) U.S. Cl. CPC G06F 17/30893; G06F 3/0487; G06F 3/167; G06F 17/30595; G06F 3/0481
USPC 715/234

(57) ABSTRACT

The present invention involves methods, systems, and apparatus for providing a dynamic guided tour system. In one aspect, a method includes receiving a target website; categorizing content of the target website; storing the content of the target website to a data store; generating a sitemap for the target website containing a URL and an ID; storing the URL and the ID in the data store; reading the content, the URL, and the ID in the data store as list data; generating a presentation based on the list data; and presenting the presentation to a user. Other aspects include providing a guided tour presentation; modifying list data to match curated data on a secondary data store; examining DOM structures; navigating through commands including device shortcuts and vocal commands; supplying curated data through crowdsourcing, and linearly concatenating the guided tour.

### CROSS-REFERENCE TO RELATED APPLICATIONS

This application claims the benefit under 35 U.S.C. §119(e) to co-pending U.S. Provisional Patent Application No. 61/889,239, filed Oct. 10, 2013, which is incorporated herein by reference in its entirety.

### GRANT STATEMENT

This invention was made with government support under IIS-1018054 awarded by the National Science Foundation. The Government has certain rights in the invention.

### BACKGROUND

This specification relates to the field of software applications. More specifically, the present invention is in the technical field of software text-to-speech.

Navigation on the Internet through a web browser typically includes a user inputting a website address and then being presented with an index page (also known as a homepage, front page, main page, etc.). The user may then parse the index page for content if he or she is searching for something specific (e.g., when searching for a specific news story) and/or browse the page generally for anything of interest (e.g., when searching for an interesting news story). The user may then select content for presentation.

However, oftentimes when navigating through a collection of content, index navigation does not provide intuitive progression through the content collection. As today's Internet websites become increasingly interactive and complex, users are forced to sift through ever more cruft to arrive at a destination. For example, when searching for a specific piece of content (e.g., a specific news story), a user may have to parse pages of irrelevant information and/or click on a number of irrelevant links (only to have to jump back to the index page again to try a different link). Such a process can be inefficient, tedious, and frustrating, especially when a user is strained for time and/or resources.

Further, index navigation presents serious issues for those with disabilities, such as blindness; poor visual acuity and/or perception (e.g., from macular or retinal degeneration; glaucoma; etc.); attention deficiencies; etc. Without the ability to effectively parse an index, a user is unable to comprehend the order of a website and therefore unable to extract useful information. Even through the use of traditional screen readers, which reads aloud a the presented information to a user, a user may be required to exert extraordinary amounts of attention to parse a screen reader's output, remember cues, select content on an interface that is typically designed for visual processing.

The present novel technology addresses these needs.

### SUMMARY

This specification describes technologies relating to creation of dynamic guided tours for screen readers through a dynamic guided tour system.

Embodiments of the present invention include—among other features, functions, and capabilities—systems and methods of creation of content into guided tours.

One embodiment may include a method for reading content on a screen by categorizing content of the target website; storing the content of the target website to a data store; generating a sitemap for the target website containing a URL and an ID; storing the URL and the ID in the data store; reading the content, the URL, and the ID in the data store as list data; generating a presentation based on the list data; and presenting the presentation to a user. Further implementations may include modifying the list data to match curated data on a secondary data store; the presentation being formatted as a guided tour; examining a document object model (DOM) structure; navigation through commands including input device shortcuts and vocal commands; crowdsourcing the curated data; linearly concatenating the guided tour; and extracting and storing a plurality of URLS and IDs.

Another embodiment may include a system for reading content on a screen including a user device; a computer operable to interact with the user device; and a network connecting the user device and the computer; wherein the computer is further operable to: receive a target website; categorize content of the target website; store the content of the target website to a data store; generate a sitemap for the target website containing a URL and an ID; store the URL and the ID in the data store; read the content, the URL, and the ID in the data store as list data; generate a presentation based on the list data; and present the presentation to a user. Further implementations may include modifying the list data to match curated data on a secondary data store; the presentation being formatted as a guided tour; examining a document object model (DOM) structure; navigation through commands including input device shortcuts and vocal commands; crowdsourcing the curated data; linearly concatenating the guided tour; and extracting and storing a plurality of URLS and IDs.

A further embodiment may include a computer-readable medium having instructions stored thereon, which when executed by one or more computers, causes the one or more computers to: receive a target website; categorize content of the target website; store the content of the target website to a data store; generate a sitemap for the target website containing a URL and an ID; store the URL and the ID in the data store; read the content, the URL, and the ID in the data store as list data; generate a presentation based on the list data; and present the presentation to a user. Further implementations may include modifying the list data to match curated data on a secondary data store; the presentation being formatted as a guided tour; examining a document object model (DOM) structure; navigation through commands including input device shortcuts and vocal commands; crowdsourcing the curated data; linearly concatenating the guided tour; and extracting and storing a plurality of URLS and IDs.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which the dynamic guided tour system may exist.

FIG. 2 is system diagram of an example computer system that may be used to create the dynamic guided tour system.

FIG. 3 depicts an example overview of the Web Structure Analyzer component of the dynamic guided tour system.

FIG. 4 depicts an example parsing of a website homepage by the dynamic guided tour system.

FIG. 5 depicts an example parsing of a website subpage by the dynamic guided tour system.

FIG. 6 is a process flow chart associated with an implementation of the dynamic guided tour system.

FIG. 7 is a process flow chart of a subpart of the process of FIG. 6 illustrating partitioning and filtering of a target website.

FIG. 8 is a process flow chart of a subpart of the process of FIG. 6 illustrating generation of a target website sitemap.

FIG. 9 is a sample differential timeline comparing usage of a guided-tour navigation from the dynamic guided tour system against a traditional, index navigation system.

Like reference numbers and designations in the various drawings indicate like elements.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” an and the include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not. Additionally, “generates,” “populates,” “generating,” and “populating” mean that the dynamic guided tour system 105, client, end user (user, system user), and/or module may produce some event or cause some event element to be produced. For example, a webpage may receive data to display in whole or in part to display a valuation estimate to an end user device, the webpage may pull such data from a source other than the dynamic guided tour system 105 (e.g., other servers, intermediaries, etc.), or the dynamic guided tour system 105 may entirely provide the valuation estimate to be produced on the webpage.

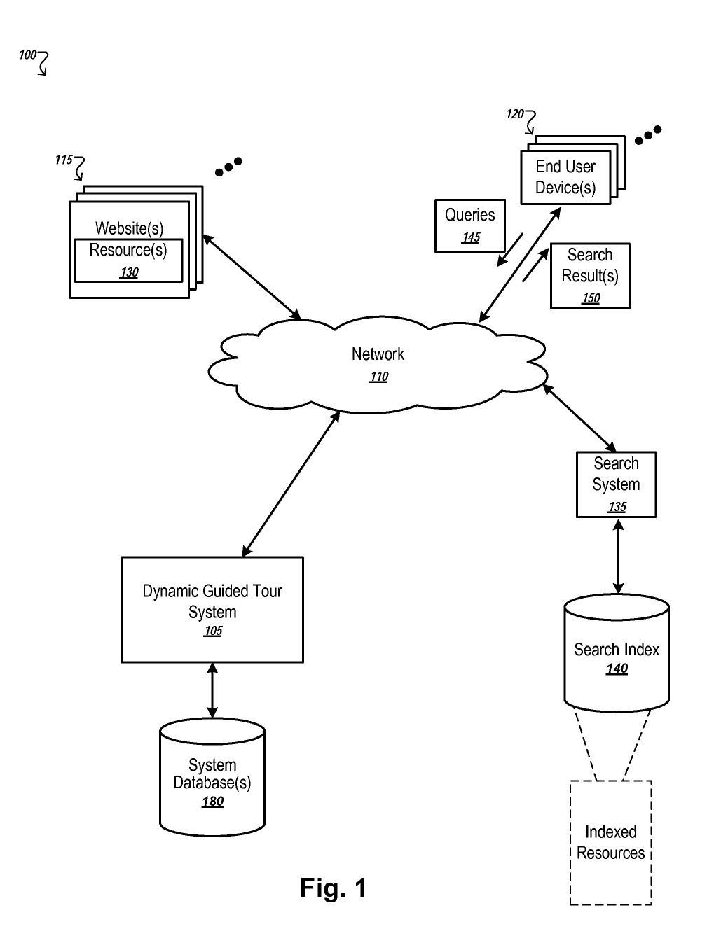

FIG. 1 is a block diagram of an example environment 100 in which dynamic guided tour system 105 may exist. Environment 100 may typically include dynamic guided tour system 105; network 110; website(s) 115; end user device(s) 120; resource(s) 130; search system 135; search index 140; queries 145; search result(s) 150; and system database(s) 180. Dynamic guided tour system 105 may facilitate construction of dynamic guided tours for screen readers. Example environment 100 also includes network 110, such as a local area network (LAN), a wide area network (WAN), the Internet, or a combination thereof. Network 110 may connect websites 115, end user device(s) 120, and/or dynamic guided tour system 105. Example environment 100 may potentially include many thousands of website(s) 115 and/or end user device(s) 120.

Website(s) 115 may be one or more resources 130 associated with a domain name and hosted by one or more servers. An example website(s) 115 may be a collection of webpages formatted in hypertext markup language (HTML) that may contain text, images, multimedia content, and programming elements, such as scripts. Each website(s) 115 may be maintained by a publisher, which may be an entity that controls, manages, and/or owns each website(s) 115.

Resource(s) 130 may be any data that may be provided over the network 110. A resource(s) 130 may be identified by a resource address (e.g., a URL) that may be associated with the resource(s) 130. Resources 130 include HTML webpages, word processing documents, and portable document format (PDF) documents, images, video, and feed sources, to name only a few. Resources 130 may include content, such as words, phrases, images and sounds, that may include embedded information—such as meta-information in hyperlinks—and/or embedded instructions, such as JAVASCRIPT scripts (JAVASCRIPT is a registered trademark of Sun Microsystems, Inc., a Delaware corporation, located at 4150 Network Circle Santa Clara, Calif. 95054). Units of content—for example, data files, scripts, content files, or other digital data—that may be presented in (or with) resources may be referred to as content items.

End user devices 120 may be electronic devices that may be under the control of an end user and may be capable of requesting and receiving resources 130 over network 110. Example end user devices 120 include personal computers, mobile communication devices, and other devices that may send and receive data over the network 110. End user devices 120 typically include a user application, such as a web browser, to facilitate the sending and receiving of data over the network 110.

In some implementations, websites 115 (apps, client services; hereinafter simply “websites” for ease of use), end user devices 120, and system 105 may directly intercommunicate, excluding the need for the Internet from the scope of a network 110. For example, the websites 115, end user devices 120, and the dynamic guided tour system 105 may directly communicate over device-to-device (D2D) communication protocols (e.g., WI-FI DIRECT (WI-FI DIRECT is a registered trademark of Wi-Fi Alliance, a California corporation, located at 10900-B Stonelake Boulevard, Suite 126, Austin, Tex. 78759); Long Term Evolution (LTE) D2D (LTE is a registered trademark of Institut Europeen des Normes; a French nonprofit telecommunication association, located at 650 route des Lucioles, F-06921, Sophia Antipolis, France), LTE Advanced (LTE-A) D2D, etc.), wireless wide area networks, and/or satellite links thus eliminate the need for the network 110 entirely. In other implementations, the websites 115, end user devices 120, and system 105 may communicate indirectly to the exclusion of the Internet from the scope of the network 110 by communicating over wireless wide area networks and/or satellite links. Further, end user devices 120 may similarly send and receive search queries 145 and search results 150 indirectly or directly.

In wireless wide area networks, communication primarily occurs through the transmission of radio signals over analog, digital cellular, or personal communications service (PCS) networks. Signals may also be transmitted through microwaves and other electromagnetic waves. At the present time, most wireless data communication takes place across cellular systems using second generation technology such as code-division multiple access (CDMA), time division multiple access (TDMA), the Global System for Mobile Communications (GSM) (GSM is a registered trademark of GSM MoU Association, a Swiss association, located at Third Floor Block 2, Deansgrande Business Park, Deansgrande, Co Dublin, Ireland), Third Generation (wideband or 3G), Fourth Generation (broadband or 4G), personal digital cellular (PDC), or through packet-data technology over analog systems such as cellular digital packet data (CDPD) used on the Advance Mobile Phone System (AMPS).

The terms “wireless application protocol” and/or “WAP” mean a universal specification to facilitate the delivery and presentation of web-based data on handheld and mobile devices with small user interfaces. “Mobile Software” refers to the software operating system that allows for application programs to be implemented on a mobile device such as a mobile telephone or PDA. Examples of Mobile Software are JAVA and JAVA ME (JAVA and JAVA ME are trademarks of Sun Microsystems, Inc. of Santa Clara, Calif.), BREW (BREW is a registered trademark of Qualcomm Incorporated of San Diego, Calif.), WINDOWS Mobile (WINDOWS is a registered trademark of Microsoft Corporation of Redmond, Wash.), PALM OS (PALM is a registered trademark of Palm, Inc. of Sunnyvale, Calif.), SYMBIAN OS (SYMBIAN is a registered trademark of Symbian Software Limited Corporation of London, United Kingdom), ANDROID OS (ANDROID is a registered trademark of Google, Inc. of Mountain View, Calif.), and IPHONE OS (IPHONE is a registered trademark of Apple, Inc. of Cupertino, Calif.), and WINDOWS PHONE 7 (WINDOWS PHONE is a registered trademark the Microsoft Corporation of Redmond, Wash.). “Mobile Apps” refers to software programs written for execution with Mobile Software.

The dynamic guided tour system 105 may use one or more modules to perform various functions including, but not limited to, searching, analyzing, querying, interfacing, etc. A “module” refers to a portion of a computer system and/or software program that carries out one or more specific functions and may be used alone or combined with other modules of the same system or program. For example, a module may be located on the dynamic guided tour system 105 (e.g., on the servers of system 105, i.e., server-side module), on end user devices 120, or on an intermediary device (e.g., the client server, i.e., a client-side module; another end user device(s) 120; a different server on the network 110; or any other machine capable of direct or indirect communication with system 105, websites 115, the search system 135, and/or the end user devices 120.)

In some implementations, the system 105 may be performed through a system 105 module. For example, a user may install a program to interface with a system 105 server to communicate data, interactions, and guided tours to the user's end user device(s) 120. In some other implementations, the system 105 may be installed on a user's machine and operate—in whole or in part—independently of system 105 WAN and/or LAN components. For example, the system 105 software may be deployed to a user's computer as a standalone program that interfaces with the user's computer, creates and maintains data store(s), generates sitemaps, parses website information, generates guided tours, etc. In another example, the system 105 may interact with and/or be installed as an Internet browser extension. For example, the system 105 may be a program installed as an extension, add-on, and/or plugin of GOOGLE CHROME (GOOGLE CHROME is a registered trademark of Google, Inc., a Delaware corporation, located at 1600 Amphitheatre Parkway, Mountain View, Calif. 94043); MOZILLA FIREFOX (MOZILLA and FIREFOX are registered trademarks of the Mozilla Foundation, a California non-profit corporation, located at 313 East Evelyn Avenue, Mountain View, Calif. 94041); APPLE SAFARI (APPLE and SAFARI are registered trademarks of Apple, Inc., a California corporation, located at 1 Infinite Loop, Cupertino, Calif. 95014), etc. The browser extension may query an entered website, parse the website's hierarchy, create sitemaps, communicate with data store(s), analyze webpages, communicate with secondary data store(s) for curation, generate guided tours, present the user with the generated guided tour, etc.

In some implementations, navigation through a guided tour may be accomplished through a user's input of commands. For example, a user may vocally command the system 105 to advance to the next page by saying “Next page,” go back by saying “Go back,” bookmark a page by saying “Bookmark this page,” etc. In another example, a user may input commands on an input device (e.g., a keyboard, touchpad, etc.) to command the system 105 (e.g., press Alt+→to go forward; Alt+←to go back; Alt+B to bookmark a webpage, etc.).

Typically, modules may be coded in JAVASCRIPT, PHP, or HTML, but may be created using any known programming language (e.g., BASIC, FORTRAN, C, C++, C#, PERL (PERL is a registered trademark of Yet Another Society DBA The Perl Foundation, a Michigan nonprofit corporation, located at 340 S. Lemon Ave. #6055, Walnut, Calif. 91789)) and/or package (e.g., compressed file (e.g., zip, gzip, 7zip, RAR (RAR is a registered trademark of Alexander Roshal, an individual, located in the Russian Federation AlgoComp Ltd., Kosareva 52b-83, Chelyabinsk, Russian Federation 454106), etc.), executable, etc.).

In some implementations, the dynamic guided tour system 105 may be packaged, distributed, scripted, installed by a technician of system 105, and/or otherwise deployed to a client server location such that system 105 exists within the client server and/or client server network, either in whole or in part. For example, the dynamic guided tour system 105 may be scripted and/or packaged into an executable package and downloaded by a client administrator; the client administrator then installing system 105 software package(s) onto the client server(s). Such setups may allow the dynamic guided tour system 105 to operate all system 105 operations entirely within the client server(s) and/or client network, excluding the need to interface with system 105 provider's servers for some or all system 105 functions. Such an implementation may, for example, be used to reduce bandwidth, latency, complexity of network management, etc. In some other implementations, the client servers may facilitate only some of system 105 functions and interface with system 105 servers (over a network or directly) to enable those remaining functions. Still other implementations may link to system 105 servers to obtain updates, patches, and/or other modifications to system 105 distributions.

Dynamic guided tour system 105 software distributions may, in some implementations, be installed in a virtual environment (e.g., HYPER-V (HYPER-V is a registered trademark of Microsoft, a Washington Corporation, located at One Microsoft Way, Redmond, Wash. 98052); VIRTUALBOX (VIRTUALBOX is a registered trademark of Oracle America, Inc., a Delaware corporation, located at 500 Oracle Parkway, Redwood Shores, Calif. 94065); VMWARE (VMWARE is a registered trademark of VMWare, Inc., a Delaware corporation, located at 3401 Hillview Ave., Palo Alto, Calif. 94304), etc.).

In other implementations, dynamic guided tour system 105 software may be installed in whole or in part on an intermediary system that may be separate from the client and system 105 servers. For example, dynamic guided tour system 105 software may be installed by an intermediary worker, a client worker, and/or a system 105 worker onto a hosting service (e.g., AMAZON WEB SERVICES (AWS) (AWS is a registered trademark of Amazon Technologies, Inc., a Nevada corporation, located at PO Box 8102, Reno, Nev. 89507), RACKSPACE (RACKSPACE is a registered trademark of Rackspace US, Inc., a Delaware corporation, located at 1 Fanatical Place, City of Windcrest, San Antonio, Tex. 78218), etc. The client may then connect to the intermediary and/or system 105 servers to access system 105 functions. Such implementations may, for example, allow distributed access, redundancy, decreased latency, etc.

End user device(s) 120 may request resources 130 from website(s) 115. In turn, data representing resource(s) 130 may be provided to end user device(s) 120 for presentation by end user device(s) 120. Data representing resource(s) 130 may also include data specifying a portion of the resource(s) 130 or a portion of a user display—for example, a small search text box or a presentation location of a pop-up window—in which advertisements or third-party search tools may be presented.

To facilitate searching of resource(s) 130, environment 100 may include a search system 135 that identifies resource(s) 130 by crawling and indexing resource(s) 130 provided by publishers on website(s) 115. Data about resource(s) 130 may be indexed based on resource(s) 130 to which the data corresponds. The indexed and, optionally, cached copies of resource(s) 130 may be stored in, for example, search index 140.

End user device(s) 120 may submit search queries 145 to search system 135 over network 110. In response, search system 135 accesses search index 140 to identify resource(s) 130 that may be relevant to search query 145. Search system 135 identifies the resources 130 in the form of search result(s) 150 and returns the search result(s) 150 to end user devices 120 in search results webpages. A search result(s) 150 may be data generated by the search system 135 that identifies a resource(s) 130 that may be responsive to a particular search query, and includes a link to the resource(s) 130. An example search result(s) 150 may include a webpage title, a snippet of text or a portion of an image extracted from the webpage, and the URL of the webpage.

Users that may be interested in a particular subject may perform a search by submitting one or more queries 145 to search system 135 in an effort to identify related information. For example, a user that may be interested sports may submit queries 145 such as “news,” “sports,” or “technology.” In response to each of these queries 145, the user may be provided search result(s) 150 that have been identified as responsive to the search query—that is, have at least a minimum threshold relevance to the search query, for example, based on cosine similarity measures or clustering techniques. The user may then select one or more of the search result(s) 150 to request presentation of a webpage or other resource(s) 130 that may be referenced by a URL associated with the search result(s) 150.

Other implementations of the dynamic guided tour system 105 may allow for a game-like components, or gamification, aspect to interaction with system 105. For example, tangible (e.g., money, goods, etc.) and/or intangible (e.g., account badges, user name flair, etc.) rewards may be given to users who donate money to system 105, users voted most active on system 105, etc.

When search result(s) 150 are requested by an end user device(s) 120, the dynamic guided tour system 105 may receive a request for data to be provided with the resource(s) 130 or search results 150. In response to the request, the dynamic guided tour system 105 selects data that are determined to be relevant to the search query. In turn, the selected data are provided to the end user device(s) 120 for presentation with the search results 150.

For example, in response to the search query “restaurant,” system 105 may present the user with relevant food and/or restaurant-related results. If the user selects—for example, by clicking or touching—search result(s) 150, the end user device(s) 120 may be redirected, for example, to a webpage containing compiled restaurant reviews by diners. This webpage may include, for example, where to go on a date, what restaurants to eat at on vacations, etc.

The environment 100 may also include a system database(s) 180 to receive and record information regarding the dynamic guided tour system 105, website(s) 115, end user devices 120, and/or any other data useful to environment 100. For example, information regarding end user devices 120 and end user identifiers may be stored and analyzed to determine user activity on website(s) 115 and/or system 105.

In some implementations, data that may be stored in the system database(s) 180 may be anonymized to protect the identity of the user with which the user data may be associated. For example, user identifiers may be removed from the user data to provide to third-party clients. Alternatively, the user data may be associated with a hash value of the user identifier to anonymize the user identifier. In some implementations, data are only stored for users that opt-in to having their data stored. For example, a user may be provided an opt-in/opt-out user interface that allows the user to specify whether they approve storage of data associated with the user.

While system 105 may operate with only one of each component (e.g., one system 105, one website 115, one end user, one end user device 120, etc.), system 105 may be benefitted by multiple of these components (and/or in some instances greatly benefitted by a mass amount of said components). For example, the existence and activity of a plurality of users on system 105 may foster greater creativity and flexibility of feedback to system 105 as compared to creative and intellectual stagnation that may typically occur with a small user base. Additionally, features such as game-like interaction of system 105 may be difficult or impossible without at least a small plurality of active competitors on system 105; however, as the number of active users increases, the likelihood of a successful ecosystem for the game-like system 105 features also increases and may tend to lead to greater success of system 105 and user activity (quantity and quality) compared to a small user base.

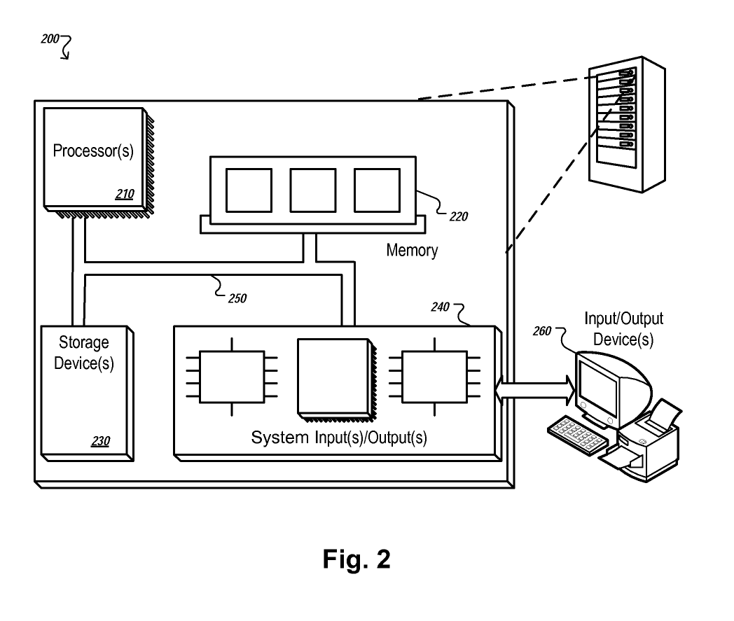

FIG. 2 is a block diagram of an example computer system 200 that may be used to provide dynamic guided tour system 100, as described above. The system 200 may typically include processor(s) 210; memory 220; storage device(s) 230; system input(s)/output(s) 240; system bus(es) 250; and input/output device(s) 260. Each of the components 210, 220, 230, and 240 typically may be interconnected, for example, using system bus(es) 250. Processor(s) 210 may be capable of processing instructions for execution within the system 200. In one implementation, processor(s) 210 may be a single-threaded processor. In another implementation, processor(s) 210 may be a multi-threaded processor. In yet another implementation, processor(s) 210 may be a single-core processor, a multiple-core processor, and/or multiple processors (i.e., more than one socketed processor). Processor(s) 210 typically may be capable of processing instructions stored in the memory 220 and/or on the storage device(s) 230.

Memory 220 stores information within system 200. In one implementation, memory 220 may be a computer-readable medium. In one other implementation, memory 220 may be a volatile memory unit. In another implementation, memory 220 may be a nonvolatile memory unit.

Storage device(s) 230 may be capable of providing mass storage for the system 200. In one implementation, storage device(s) 230 may be a computer-readable medium. In various different implementations, storage device(s) 230 may include, for example, a hard disk device, a solid-state disk device, an optical disk device, and/or some other large capacity storage device.

System input(s)/output(s) 240 provide input/output operations for the system 200. In one implementation, system input(s)/output(s) 240 may include one or more of a network interface devices, for example an Ethernet card; a serial communication device, for example an RS-232 port; and/or a wireless interface device, for example an IEEE 802.11 card. In another implementation, system input(s)/output(s) 240 may include driver devices configured to receive input data and send output data to other input/output device(s) 260, for example keyboards, printers, display devices, and/or any other input/output device(s) 260. Other implementations, however, may also be used, such as mobile computing devices, mobile communication devices, set-top box television client devices, etc.

Although an example processing system has been described in FIG. 1, implementations of the subject matter and the functional operations described in this specification may be implemented in other types of digital electronic circuitry, or in computer software, firmware, or hardware, including the structures disclosed in this specification and their structural equivalents, or in combinations of one or more of them.

Embodiments of the subject matter and the operations described in this specification may be implemented as a method, in digital electronic circuitry, or in computer software, firmware, or hardware, including the structures disclosed in this specification and their structural equivalents, or in combinations of one or more of them. Embodiments of the subject matter described in this specification may be implemented as one or more computer programs—that is, one or more modules of computer program instructions encoded on computer storage medium for execution by, or to control the operation of, data processing apparatus. Alternatively or in addition, the program instructions may be encoded on an artificially-generated propagated signal, for example a machine-generated electrical, optical, or electromagnetic signal, which may be generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium may not be a propagated signal, a computer storage medium may be a source or destination of computer program instructions encoded in an artificially-generated propagated signal. The computer storage medium may also be, or be included in, one or more separate physical components or media (e.g., multiple CDs, disks, or other storage devices).

The operations described in this specification may be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus may include special purpose logic circuitry, for example an field programmable gate array (FPGA) or an application-specific integrated circuit (ASIC). The apparatus may also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment may realize various different computing model infrastructures, such as web services, distributed computing, and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program can, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, for example an FPGA or an ASIC.

Processors suitable for the execution of a computer program include, by way of example, both general and special purpose microprocessors, and any one or more processors of any kind of digital computer. Typically, a processor may receive instructions and data from a read-only memory or a random access memory or both. The essential elements of a computer are a processor for performing actions in accordance with instructions and one or more memory devices for storing instructions and data. Typically, a computer may also include, or be operatively coupled to receive data from or transfer data to, or both, one or more mass storage devices for storing data, e.g., magnetic, magneto-optical disks, or optical disks. However, a computer need not have such devices. Moreover, a computer may be embedded in another device, for example a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, for example erasable programmable read-only memory (EPROM), electrically erasable programmable read-only memory (EEPROM), and/or flash memory devices; magnetic disks, for example internal hard disks or removable disks; magneto-optical disks; and/or compact disk read-only memory (CD-ROM) and digital video disk real-only memory (DVD-ROM) disks. The processor and the memory may be supplemented by, or incorporated in, special purpose logic circuitry.

To provide for interaction with a user, embodiments of the subject matter described in this specification may be implemented on a computer having a display device (e.g., a cathode ray tube (CRT), liquid crystal display (LCD), or organic light-emitting diode (OLED) monitor), for displaying information to the user and a keyboard and a pointing device, e.g., a mouse or a trackball, by which the user may provide input to the computer. These may, for example, be desktop computers, laptop computers, smart TVs, etc. Other mechanisms of input may include portable and or console entertainment systems such as GAME BOY and/or NINTENDO DS ((GAME BOY, GAME BOY COLOR, GAME BOY ADVANCE, NINTENDO DS, NINTENDO 2DS, and NINTENDO 3DS are registered trademarks of Nintendo of America Inc., a Washington corporation, located at 4600 150th Avenue NE, Redmond, Wash. 98052), IPOD (IPOD is a registered trademark of Apple Inc., a California corporation, located at 1 Infinite Loop, Cupertino, Calif. 95014), XBOX (e.g., XBOX, XBOX ONE) (XBOX and XBOX ONE are a registered trademarks of Microsoft, a Washington corporation, located at One Microsoft Way, Redmond, Wash. 98052), PLAYSTATION (e.g., PLAYSTATION, PLAYSTATION 2, PS3, PS4, PLAYSTATION VITA) (PLAYSTATION, PLAYSTATION 2, PS3, PS4, and PLAYSTATION VITA are registered trademarks of Kabushiki Kaisha Sony Computer Entertainment TA, Sony Computer Entertainment Inc., a Japanese corporation, located at 1-7-1 Konan Minato-ku, Tokyo, 108-0075, Japan), OUYA (OUYA is a registered trademark of Ouya Inc., a Delaware corporation, located at 12243 Shetland Lane, Los Angeles, Calif. 90949), WII (e.g., WII, WII U) (WII and WII U are registered trademarks of Nintendo of America Inc., a Washington corporation, located at 4600 150th Avenue NE, Redmond, Wash. 98052), etc.

Other kinds of devices may be used to provide for interaction with a user as well; for example, feedback provided to the user may be any form of sensory feedback, for example visual feedback, auditory feedback, or tactile feedback; and input from the user may be received in any form, including acoustic, speech, or tactile input. In addition, a computer may interact with a user by sending documents to and receiving documents from a device that may be used by the user; for example, by sending webpages to a web browser on a user's client device in response to requests received from the web browser.

Some embodiments of the subject matter described in this specification may be implemented in a computing system 200 that includes a back-end component (e.g., a data server,) or that includes a middleware component (e.g., an application server,) or that includes a front-end component (e.g., a client computer having a graphical user interface or a Web browser through which a user may interact with an implementation of the subject matter described in this specification,) or any combination of one or more such back-end, middleware, or front-end components. The components of the computing system 200 may be interconnected by any form or medium of digital data communication, for example a communication network. Examples of communication networks include a local area network (LAN) and a wide area network (WAN), an inter-network (e.g., the Internet), and peer-to-peer networks (e.g., ad-hoc peer-to-peer, direct peer-to-peer, decentralized peer-to-peer, centralized peer-to-peer, etc.).

The computing system 200 may include clients and servers. A client and server are typically remote from each other and typically interact through a communication network. The relationship of client and server arises by virtue of computer programs running on the respective computers and having a client-server relationship to each other. In some embodiments, a server transmits data (e.g., an HTML webpage) to a client device (e.g., for purposes of displaying data to and receiving user input from a user interacting with the client device). Data generated at the client device (e.g., a result of the user interaction) may be received from the client device at the server.

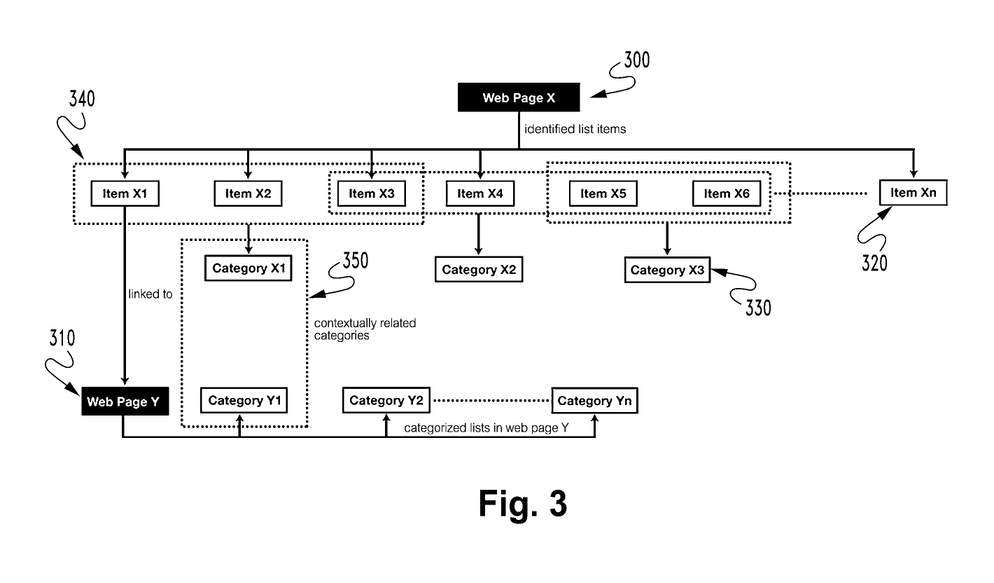

FIG. 3 depicts an example overview of the Web Structure Analyzer (WSA) component of the dynamic guided tour system 105, typically including first website 300, second website 310, identified list item 320, identified category item 330, item list 340, and category list 350. The WSA typically may be machine-learning algorithm(s) to partition a target webpage based on visual presentation, document object model (DOM) structure, and/or any other machine- and/or user-identifiable partitioning of a webpage. The WSA analyzes these partitions, extracts data, and categories webpages to identify list items specific to individual pages on the website. For example, a website may be designed with multiple panels, sections, body blocks, modules, etc. that the WSA may parse for partitions; extract these partitions for data (e.g., panel name, section title, body heading, etc.); and then categorize the extracted data in semantically- and/or contextually-related categories. Semantically-related categorization of terms may occur according to a number of metrics including, but not limited to, language, length, vector space usage, location on webpage, vocabulary, etc. Contextually-related categorization of terms also may occur according to a number of metrics including, but not limited to, assigned posting tags, user who posted content, subject matter of content, type of content, etc.

In some implementations, the WSA stores the categories and/or list items associated with categories in one or more data stores. For example, the WSA may create a database, create a table to store information, and store and/or associate categories and/or category items in the database. In some implementations, the WSA may connect to an existing data store (instead of creating a new one) and store the categories and/or items to that existing data store. In some further implementations, the data store may be internal to system 105 (e.g., a database located on system 105 servers), locally networked (e.g., on the same LAN as system 105 servers), remote (e.g., over WAN, on a cloud database implementation, etc.), and/or distributed (e.g., on multiple WAN/LAN servers, using database sharding, etc.) In some other implementations, the WSA may query existing entries in the data store, referencing redundant entries and/or storing nonredundant entries. For example, if a previous storage operation stored the string “Computer A” and the current storage operation also contains “Computer A” as a category item, system 105, data store, and/or WSA may reference the previously stored string instead of storing a new, redundant string. This may be useful to reduce latency, bandwidth, input/output operations, database size/complexity, etc.

In some other implementations, the WSA works concurrently with and/or in conjunction with the Web Crawler Engine (WCE). The WCE may extract links on a website into a sitemap. Titles of webpages on the sitemap may be assigned IDs, stored in a data store, and associated with existing and/or subsequently created entries. For example, a user may browse to a website; the WCE may crawl that website to create a sitemap and store webpages; the WSA may parse, partition, extract, and store a target webpage; and system 105 may associate the WCE entry for the target webpage with the WSA entries for the target webpage. In such a fashion, system 105 builds a connected URL, content, category, and listing for presentation to a user in a guided tour form.

In some implementations, system 105 may additionally detect, store, and/or associate user identifiers. For example, system 105 may detect and store user identifier element(s) such as date, time, end user's IP address (Internet Protocol version 4 (IPv4), Internet Protocol version 6 (IPv6), etc.), browser fingerprint (e.g, browser serial number, browser ID file, browser type, browser version, time zone, screen size, color depth, local code indicators, etc.), end user's geographic location (e.g., where end user allows location services on desktop or mobile device), etc. In some implementations, system 105 may associate these user identifier element(s) with WSA entries, WEC entries, bookmark data, user history information, etc. System 105 may then use these user identifier element(s) to determine the existence of an active user session, the last time a user used system 105, the frequency of a user's usage of the system, the amount of time spent per user session, etc.

In some implementations, the WCE may parse and store a website's sitemap, and then the WSA may preemptively extract and categorized the stored sitemap contents to generate/store categories and list items. For example, the WSA may systematically go through every category stored by the WCE to generate list items for all categories on the website; while in another example, the WSA may only go categorize and store the most prevalent and/or most prominent (e.g., appears on homepage, appears the most number of times on the homepage, appears the most number of times on the website, etc.).

In some further implementations, system 105 may utilized one or more secondary data stores for curing of stored data. For example, system 105 maintain and/or connect to a data store with public read/write access, which contains manually curated website and/or webpage categories and/or listings. This may be useful, for example, where a website and/or webpage's partitioning confuses system 105 components.

In some implementations, curated data may be obtained through crowdsourcing—in whole or in part—from contributors. For example, a secondary data store may allow any user to curate a website and/or webpage information; in another example, any user may contribute curations, but moderators may publish those curations before the system 105 may use the curated data; and in yet another implementation, curations may be only allowed from a select group of individuals (e.g., trusted sources, experts, etc.). Further, in some implementations, curated data may be published and/or validated through a rating and/or review mechanism. For example, curated data may be rated on a 1-5 scale by screen reader users, wherein a curation may be published after at least five users of an experimental user branch rate the curation at a minimum average of 3 out of 5. In another example, users may receive ratings and/or reviews of their curated data contributions, and any user with at least ten curated data submissions and a minimum of a 75% positive review rating from curated data users may automatically have his or her newly uploaded curations automatically (and/or semiautomatically) published on the curation data store.

In some implementations, curation may be done based on one or more rulesets defined by secondary data store users. For example, instead of manually curating each update of a webpage's items in a repetitive manner, a ruleset may perform the same repetitive actions. Depending on the consistency of webpage updates and the consistency of the ruleset, the ruleset-curated content may not be as precise as human-curated content, but the precision loss may be overcome by the ability to keep a webpage curation up-to-date for system 105 users. With the frequency of changes to many major websites (e.g., news, ecommerce, etc.), keeping a curation up-to-date may represent significant benefit to some users.

In some other implementations, users may configure system 105 to use only initial stored content (i.e., from the WCE and WSA); while in other implementations, system 105 may use only human-curated content; in still other implementations, system 105 may only use ruleset-curated content; and in yet other implementations, system 105 may use a combination of any of these techniques.

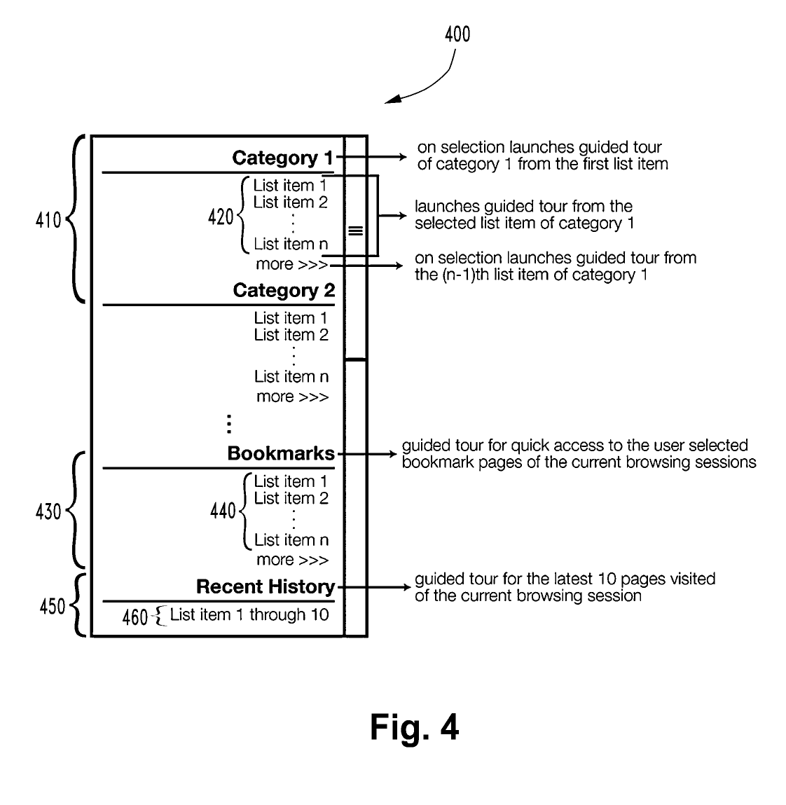

FIG. 4 depicts an example parsing of a website homepage by the dynamic guided tour system 105, typically including tour interface for homepage 400, homepage tour category 410, homepage tour item(s) 420, homepage tour bookmark list 430, homepage tour bookmark(s) 440, tour history 450, and tour history item(s) 460. Tour interface for homepage 400 typically may be generated after a user browses to and/or selects a URL. For example, a user may input “website.com” into a browser and/or screen reader, or user may click on a reference link to “website.com.”

In some implementations, tour interface for homepage 400 typically may be presented to a system 105 user visually, aurally, tactilely, and using any other presentation mechanism. In some other implementations, tour interface for homepage 400 may automatically present to the user after generation, while in others, a user may manually trigger presentation (e.g., by clicking a button, saying “present interface,” etc.).

Homepage tour category 410 may correspond to a category stored on a data store after the WSA and/or WCE extract, store, and/or associate webpage data (and/or curation if desired). For example, this may be the heading “Current Inventory” on a website. On selection of the category, system 105 may initialize a guided tour to the user. Typically, a user may first be presented with the first item of the category's list; however, system 105 and/or the user may define an alternate start point (e.g., start on the tenth list item because user has previously viewed the first nine items).

Homepage tour item(s) 420 may typically be item(s) stored on a data store after the WSA and/or WCE extract, store, and/or associate webpage data (and/or curation if desired). For example, this may be the subheading “Laptops” under the heading “Current Inventory” or a list of stories under a “Recent Events” section. In some implementations, homepage tour item(s) 420 may only be a single item, whereas in other implementations it may be a nigh infinite number of items. In other implementations, the homepage tour item(s) 420 listing may be singular item listings, whereas in other implementations it may be multiple sublists. In still other implementations, the sublists may be collapsible.

Typically, homepage tour bookmark list 430 may act similarly to homepage tour category 410 (i.e., act as a category for items, in this case homepage tour bookmark(s) 440). Homepage tour bookmark list 430 may correspond to a list of selected categories and/or items that the user may select. For example, the user may wish to quickly return to a specific laptop that he or she was presented via a guided tour, so he or she created a bookmark to reference this.

In some implementations, the homepage tour bookmark list 430 and/or homepage tour bookmark(s) 440 may be store on a local data store by system 105 and/or user, whereas in other implementations the data store may be stored elsewhere (e.g., on the LAN, on a server over the WAN, etc.). In other implementations, the homepage tour bookmark list 430 and/or homepage tour bookmark(s) 440 may be exported and/or imported as packaged data (e.g., a comma-separated value (CSV) file, a proprietary storage format, etc.).

Tour history 450 typically may act as a reference list for a certain number of recently visited tour locations and tour history item(s) 460 may correspond to those recently visited tour locations. For example, tour history item(s) 460 may be the last ten concatenated items viewed by the user in a particular category. In some implementations, tour history item(s) 460 may be separated by date, associated category, and/or any other manner of categorization.

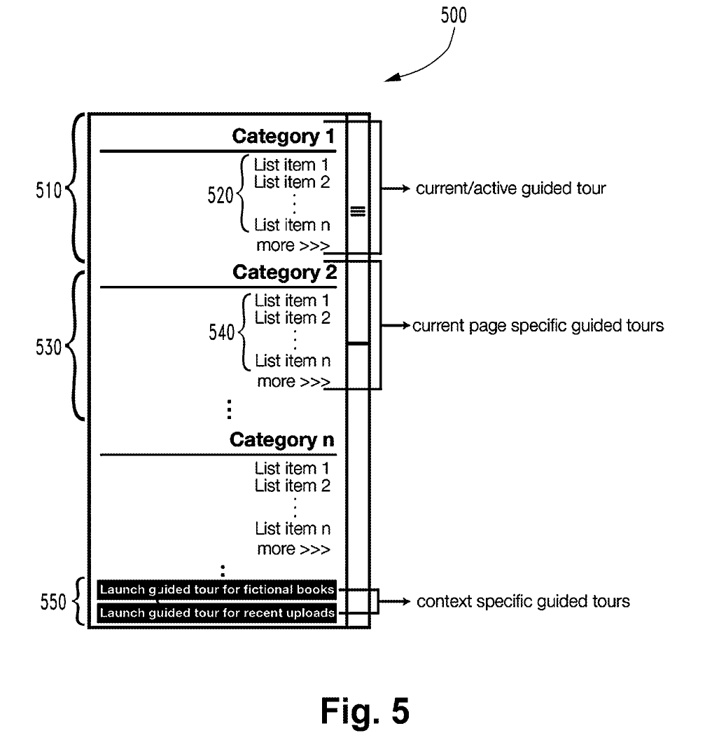

FIG. 5 depicts an example parsing of a website subpage by the dynamic guided tour system 105, typically including tour interface for webpage 500, active tour 510, active tour item(s) 520, webpage-specific tour 530, webpage-specific item(s) 540, context-specific tour(s) 550.

Similar to homepage tour category 410 and homepage tour item(s) 420, described above, active tour 510 and active tour item(s) 520 may correspond to a category and/or items stored on a data store after the WSA and/or WCE extract, store, and/or associate webpage data (and/or curation if desired). A user may first be presented with the first active tour item(s) 520, but in other implementations, system 105 and/or the user may define an alternative starting point.

In some implementations, system 105 may indicate the user's current browsing location in the list (e.g., by changing the text color of the list item, placing a symbol next to the list item, etc.). Active tour item(s) 520 may only be a single item, whereas in other implementations it may be a nigh infinite number of items. In other implementations, the active tour item(s) 520 listing may be singular item listings, whereas in other implementations it may be multiple sublists. In still other implementations, the sublists may be collapsible.

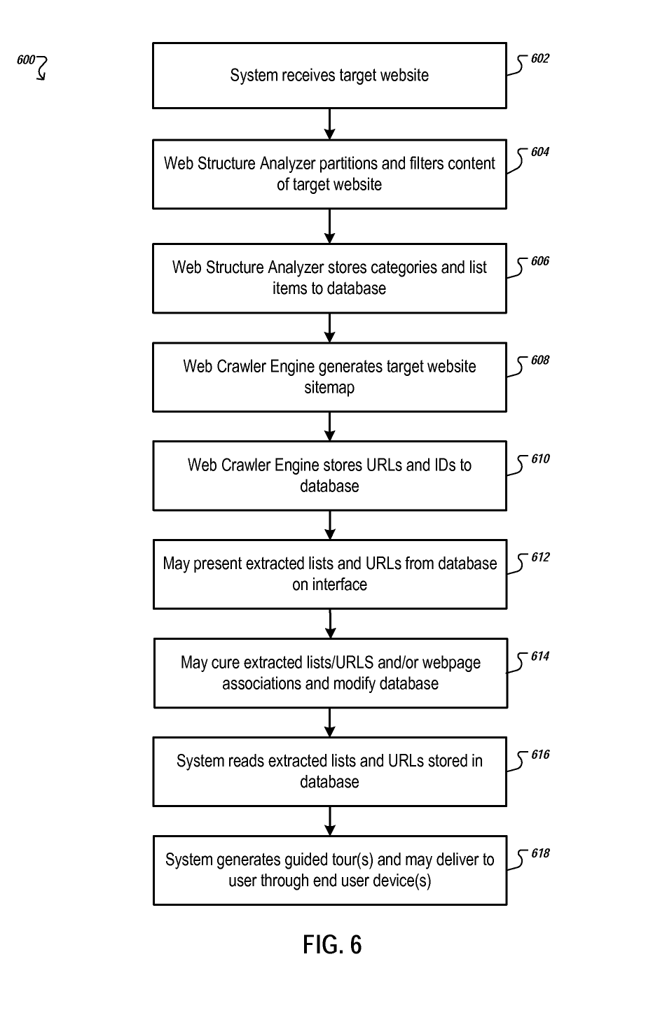

FIG. 6 depicts a process flow chart for a process general overview 600 associated with an implementation of the dynamic guided tour system 105, typically including the steps of “System receives target website” 602; “Web Structure Analyzer partitions and filters content of target website” 604; “Web Structure Analyzer stores categories and list items to database” 606; “Web Crawler Engine generates target website sitemap” 608; “Web Crawler Engine stores URLs and IDs to database” 610; “May present extracted lists and URLs from database on interface” 612; “May cure extracted lists and/or webpage associations and modify database” 614; “System reads extracted lists and URLs stored in database” 616; and “System generates guided tour(s) and may deliver to user through end user device(s)” 618.

In some instances, these steps may be repeated several times in sequential order, steps may be cyclically performed to reach a threshold, and/or one or more steps may be omitted. For example, the “Web Crawler Engine generates target website sitemap” 608 and “Web Crawler Engine stores URLs and IDs to database” 610 steps may be performed before the “Web Structure Analyzer partitions and filters content of target website” 604 and/or “Web Structure Analyzer stores categories and list items to database” 606 steps. In another example, system 105 may skip the “Web Crawler Engine generates target website sitemap” 608 and “Web Crawler Engine stores URLs and IDs to database” 610 steps because they have already been performed and the user is merely browsing to another webpage on the website, thus triggering WSA to parse the new webpage.

The “System receives target website” 602 step may typically be performed by system 105 and/or a module of system 105 after a user inputs and/or clicks on a reference to a website. For example, the user may type in “website.com” or click on an icon linked to “website.com.”

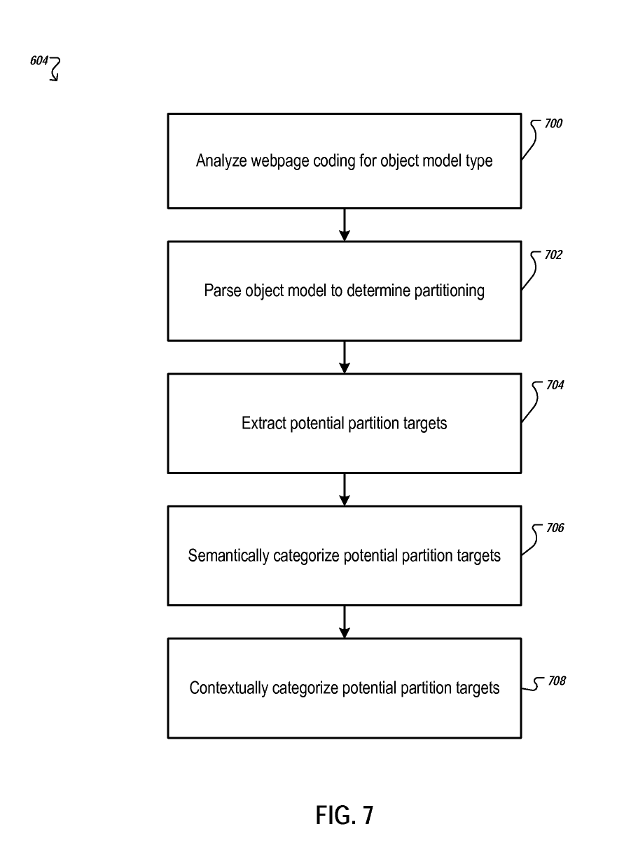

The “Web Structure Analyzer partitions and filters content of target website” 604 step may typically be performed by system 105 and/or a module of system 105 (e.g., a browser extension). As described above, the WSA may parse a webpage, partition the webpage, extract data, and categorize extracted data. The “Web Structure Analyzer partitions and filters content of target website” 604 step is explained in greater detail with relation to FIG. 7 and the associated portions of this disclosure hereafter.

The “Web Structure Analyzer stores categories and list items to database” 606 step may typically be performed by system 105 and/or a module of system 105. After the WSA partitions and filters content on a webpage, system 105 stores the extracted and/or categorized data in a data store. For example, the WSA may extract and categorize all the headings of a website homepage as categories 1-5, and then associate all the subheadings under each heading as category items. Storing of the categories and category items may be on a data store local to system 105 (e.g., system database 180), a networked data store (e.g., on the LAN), a remote data store (e.g., over the WAN), and/or a combination of the above.

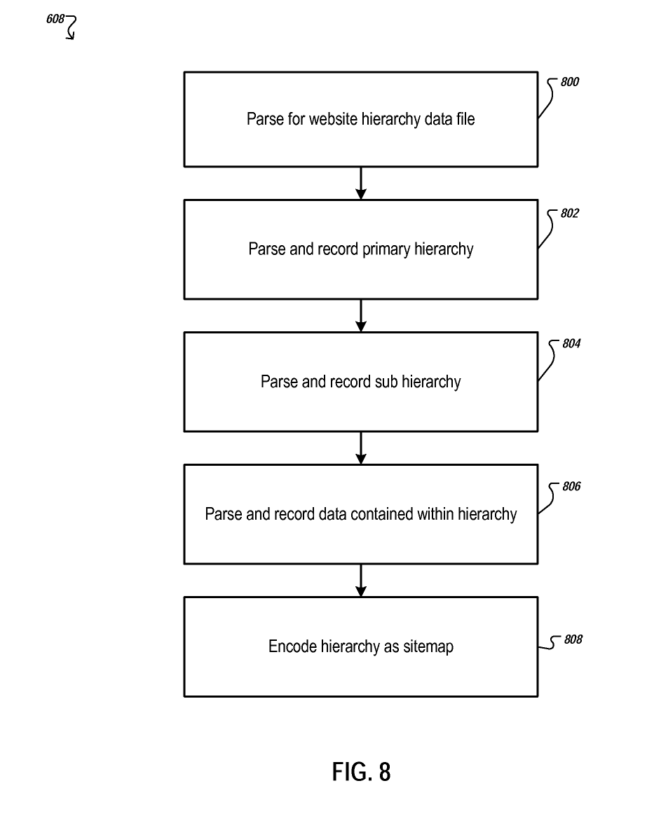

The “Web Crawler Engine generates target website sitemap” 608 step may typically be performed by system 105 and/or a module of system 105. As described above, the WCE parses a website's hierarchy to generate a sitemap for the target website. For example, the WCE may parse “website.com” and map out all the headings and subheading webpages, including all the webpages to which each webpage links (e.g., heading 1 links to headings 1-3 and subheadings 3-8 of heading 2; heading 2 links to headings 3-4 and subheadings 1-2, 4 of heading 9; etc.). The WCE typically may assign webpages and URLs found when generating the sitemap unique identifiers (e.g., “website.com.1, website.com.2, etc.) and associate these unique identifiers. The “Web Crawler Engine generates target website sitemap” 608 step is explained in greater detail with relation to FIG. 8 and the associated portions of this disclosure hereafter

The “Web Crawler Engine stores URLs and IDs to database” 610 step may typically be performed by system 105 and/or a module of system 105. Typically, this step operates similarly to the “Web Structure Analyzer stores categories and list items to database” 606 step. In some implementations, the “Web Structure Analyzer stores categories and list items to database” 606 and the “Web Crawler Engine stores URLs and IDs to database” 610 steps may operate concurrently, while in other implementations they may operate separately but cooperatively. For example, the “Web Crawler Engine stores URLs and IDs to database” 610 step and the “Web Structure Analyzer stores categories and list items to database” 606 step may both run when a user browses to a website homepage for the first time, but for each webpage of a website browsed to by a user after this first time only the “Web Structure Analyzer stores categories and list items to database” 606 step may run (using the sitemap previously generated).

In some implementations, system 105 may associate unique identifiers with other unique identifiers as the data is stored on the data store. In other implementations, these associations may be cataloged as the sitemap is generated, and this catalog may then be merged into the database during the “Web Crawler Engine stores URLs and IDs to database” 610 step. As above, storing of the categories and category items may be on a data store local to system 105 (e.g., system database 180), a networked data store (e.g., on the LAN), a remote data store (e.g., over the WAN), and/or a combination of the above.

In other implementations, the data stored from the WCE sitemap generation may also be associated with data stored from the WSA operation. For example, unique identifiers may be assigned to each category and/or item extracted and categorized by the WSA, and then the WCE sitemap data (e.g., heading 1 links to heading 2, subheading 3) may be associated with the WSA categories and/or items. Such a combination may combine the overall sitemap architecture and interrelation of the WCE operation with the categorization and itemization of the WSA operation.

The “May present extracted lists and URLs from database on interface” 612 step may typically be performed by system 105 and/or a module of system 105. Typically, a user may be presented (visually, aurally, tactilely, etc.) with the extracted category and/or item list(s) and associated URLs that are stored in the database on an interface. For example, the interface may be a popup window, a screen reader summary, and/or any other presentation mechanism.

In some implementations, the user may use this step to determine if curing by an additional source may be desired (e.g., because the website was difficult for system 105 modules to parse). In other implementations, a user may select whether or not to perform this step. For example, a user may wish to skip this presentation step and just have system 105 present a guided tour. In another example, a user may always wish system 105 to use a curated list and to skip this step.

The “May cure extracted lists and/or webpage associations and modify database” 614 step may typically be performed by system 105, a module of system 105, and/or users of system 105 (who maintain a third-party data store). Typically, as discussed above, system 105 may utilized one or more secondary data stores for curing of stored data. For example, system 105 maintain and/or connect to a data store with public read/write access, which contains manually curated website and/or webpage categories and/or listings.

Further, in some implementations, curation may be done based on one or more rulesets defined by secondary data store users. For example, instead of manually curating each update of a webpage's items in a repetitive manner, a ruleset may perform the same repetitive actions. While ruleset-curated content may not be as precise as human-curated content, the precision loss may be overcome by the ability to keep a webpage curation up-to-date for system 105 users.

In some other implementations, users may configure system 105 to use only initial stored content (i.e., from the WCE and WSA); while in other implementations, system 105 may use only human-curated content; in still other implementations, system 105 may only use ruleset-curated content; and in yet other implementations, system 105 may use a combination of any of these techniques. For example, the use may wish to always have a static (or nearly static) webpage human-curated, a recent news website to be ruleset-curated, and/or a web log(blog) to use a combination curation (e.g., ruleset-curated for recent blog posts; human-curated for infrequently-updated “About the Author” webpage).

In some implementations, the curated data from the secondary data store may be merged with the data in the primary data store—in whole or in part—whereas in other implementations, the curated data may replace the data in the primary data store. For example, system 105 and/or a system 105 may perform a differential analysis of the primary data store data and the secondary data store data, deprecating and replacing any primary data store data that does not match similar entry fields (e.g., heading 1 may be akin to heading 1).

In other implementations, system 105 may immediately query the secondary data store upon system 105's receiving of the target website in the “System receives target website” 602 step (thus skipping the WSA and/or WCE operations) or may query the secondary data store upon occurrence of an event. For example, system 105 and/or system 105 module may defer to the secondary data store automatically and/or after system 105 and/or system 105 module, upon parsing the webpage, detect an error state (e.g., no categories detected, single category detected with no items, etc.).

The “System reads extracted lists and URLs stored in database” 616 step may typically be performed by system 105 and/or a module of system 105. Typically, after the webpage has been parsed, sitemapped, categorized, stored, associated, and/or curated, system 105 may then prepare the categories and list for presentation as a guided tour. For example, system 105 may query the primary and/or secondary data stores for categories and item(s) matching the current session (i.e., using user identifier element(s), described above).

Finally, the “System generates guided tour(s) and may deliver to user through end user device(s)” 618 step may typically be performed by system 105 and/or a module of system 105. Once system 105 and/or system 105 module retrieve the current session's categories and/or items, system 105 and/or system 105 module may generate guided tour(s) for a system 105 user. In some implementations, the generated guided tour(s) may first be saved as a local file or it may be generated on-the-fly with access the primary and/or secondary data stores as the user's selections on the guided tour(s) necessitate. For example, caching a homepage of a website may be beneficial where a user may jump back-and-forth while searching for piece(s) of data (e.g., a company's contact information, a company's hours of operation, etc.). In some other implementations, system 105 may use a template to generate the guided tour(s); in other implementations, system 105 may generate the guide tour(s) from scratch based on the data in the primary and/or secondary data stores; and in yet another implementation, system 105 may use a template for some parts of a guide tour(s) generation, while generating other guide tour(s) parts from scratch.

In some implementations, the content of the guided tour may be linearly concatenated. For example, the system 105 and/or system 105 module may chain each item of a category in order (i.e., user clicks on category A and is presented with item A1; user advances guided tour while on item A1 and is presented with item A2; user reverses guided tour while on item B7 and is presented with item B6; etc.). In other implementations, a user may be presented with other presentations in a concatenated fashion. For example, bookmarks may be presented to the user in the order in which they appear in a data store. Such concatenation may allow a user to navigate through a website and/or webpages in a slideshow-type manner.

FIG. 7 is a subflow of the “Web Structure Analyzer partitions and filters content of target website” 604 step of FIG. 6 and may typically include the substeps of “Analyze webpage coding for object model type” 700; “Parse object model to determine partitioning” 702; “Extract potential partition targets” 704; “Semantically categorize potential partition targets” 706; and “Contextually categorize potential partition targets” 708. In some instances, these steps may be repeated several times in sequential order, steps may be cyclically performed to reach a threshold, and/or one or more steps may be omitted.

The “Analyze webpage coding for object model type” 700 step typically may be performed by system 105 and/or a module of system 105. Typically, a webpage may be encoded using a standard object model. For example, a webpage may be coded with deference to the document object model (DOM), which is a cross-platform, language-independent convention for representing and interacting with objects in HTML, extensible hypertext markup language (XHTML), and extensible markup language (XML) documents. The documents are organized in a tree-like structure (a “DOM tree”). Public interface to a DOM structure may typically be provided using an API.

In other implementations, DOM structure analysis may be performed by system 105 and/or system 105 module using an analyzer (similar to the WSA and/or WCE). For example, the system 105 may implement a DOM Structure Analyzer (DSA) that identifies different Cascading Style Sheets (CSS) classes used in a website. The DSA may then parse identified data to extract categories and/or links listed in those categories. In some implementations, the DSA may be initiated by a user; while in other implementations, the DSA may be semiautomatic and/or automatic. For example, the user may say “Analyze website” to manually trigger the DSA to perform website parsing, whereas in another example, the DSA may automatically parse a new website after a user inputs the new website.

In some implementations, some webpages may additionally implement DOM manipulation packages such as JQUERY (JQUERY is a registered trademark of the jQuery Foundation, Inc., a Delaware corporation, located at 340 S. Lemon Avenue, #8665, Walnut, Mass. 91789) and/or use an alternative to DOM (e.g., Simple API for XML (SAX)). Once system 105 and/or system 105 module have determined the website object model type, the object model may be parsed for partitioning.

The “Parse object model to determine partitioning” 702 step typically may be performed by system 105 and/or a module of system 105. System 105 and/or system 105 module parse the DOM tree to determine the breakdown of the webpage's content. For example, the webpage may contain as A. two headings, B. two subheadings under each heading, C. a 3×3 table with information about the company, and D. company contact information, which may be categorized each as individual categories (i.e., A; B; C; D), subcategories (i.e., A[B]; C; D), and/or interrelated categories (i.e., A[B]; B[A]; C[D]; D[C]).

The “Extract potential partition targets” 704 step typically may be performed by system 105 and/or a module of system 105. Once system 105 and/or system 105 module determine partitioning targets (e.g., A, B, C, D), system 105 and/or system 105 module may attempt to extract the data and/or relationships from the data. For example, the system and/or system 105 module may parse the webpage and extract that A may contain all of B and C may contain several links in the table, including one link to D. In some implementations, system 105 and/or system 105 module may additionally extract information including, but not limited to, encoding format (e.g., Universal Character Set+Transformation Format-8-bit (UTF-8), American Standard Code for Information Interchange (ASCII), etc.), language (e.g., English, German, Chinese, etc.), author, copyright, modified date, etc. This data may be useful for relationship matching in the next two steps.

The “Semantically categorize potential partition targets” 706 and “Contextually categorize potential partition targets” 708 steps typically may be performed by system 105 and/or a module of system 105. Semantically-related categorization of terms may occur according to a number of metrics including, but not limited to, language, length, vector space usage, location on webpage, vocabulary, etc. For example, system 105 and/or system 105 module may categorize C and D because both contain similar strings of text, encoding information, etc. Contextually-related categorization of terms also may occur according to a number of metrics including, but not limited to, assigned posting tags, user who posted content, subject matter of content, type of content, etc. For example, A and B may be categorized together because they are both encoded in a list format as headings and subheadings.

In some implementations, some items may be standalone, whereas in other implementations, items may be associated with a number of categories. For example (continuing the above example), if system 105 and/or system 105 module extracted E. a sub-subheading and F. an advertisement, system 105 and/or system 105 module may categorize E in the category of A, the category of B, and the category of A[B]; and may categorize F as a standalone item in a miscellaneous category as it does not appear to relate to A-E.

FIG. 8 is a subflow of the “Web Crawler Engine generates target website sitemap” 608 step of FIG. 6 and may typically include the substeps of “Parse for website hierarchy data file” 800; “Parse and record primary hierarchy” 802; “Parse and record sub hierarchy” 804; “Parse and record data contained within hierarchy” 806; and “Encode hierarchy as sitemap” 808. In some instances, these steps may be repeated several times in sequential order, steps may be cyclically performed to reach a threshold, and/or one or more steps may be omitted.

The “Parse for website hierarchy data file” 800 step typically may be performed by system 105 and/or a module of system 105. Typically, system 105 and/or system 105 module may parse the website homepage and/or index for a sitemap file. For example, the website may already have a sitemap generated as an XML file for search engines to use. In some implementations, the website may have a user-viewable HTML sitemap (where all webpages may be linked under each directory/subdirectory as hypertext links). In either of the cases, system 105 and/or system 105 module may utilize and/or parse the existing website sitemap instead of generating a new sitemap. However, in cases where the existing sitemap is out-of-date (i.e., determined by comparing the last modified date of the sitemap file to the current date and rejecting the sitemap if older than six months) and/or nonexistent, system 105 and/or system 105 module may parse the website hierarchy and generate a sitemap.

The “Parse and record primary hierarchy” 802 step typically may be performed by system 105 and/or a module of system 105. Typically, system 105 and/or system 105 module may parse the website's server(s) to determine the overall hierarchy of the website. For example, a website visitor may be able to browse to “/website” as an index/homepage, which may then have three primary directories: “website/company”, “website/products”, and “website/support”. These three directories may then each for a branch (three total) on a sitemap tree. In some implementations, this sitemap tree may be coded as an XML file, an HTML file, and/or any other digital format capable of expressing a hierarchy with multiple branches and sub-branches. In some other implementations, system 105 and/or system 105 module may record these branches into a data store (e.g., system database 180). For example, the data store may contain a table wherein “index”=1[ ], “company”=2[1], “products”=3[1], and “support”=4[1] (wherein the data store structure may be ‘“[page]”=[page_ID][[parent_ID]]’).

The “Parse and record sub hierarchy” 804 step typically may be performed by system 105 and/or a module of system 105. Similar to the “Parse and record primary hierarchy” 802 step, the “Parse and record sub hierarchy” 804 step goes further down the hierarchy chain to determine subdirectories. For example, system 105 and/or system 105 module may parse the above website and find four subdirectories: “website/company/aboutus”, “website/products/laptops”, “website/products/desktops”, and “website/support/contact”. As above, system 105 and/or system 105 module may code these subdirectories into the sitemap tree as branches (this time underneath their respective primary directories). System 105 and/or system 105 module may also record these branches to a data store, as described above (e.g., “aboutus”=4[2], “laptops”=5[3], “desktops”=6[3], and “contact”=7[4]).

The “Parse and record data contained within hierarchy” 806 step typically may be performed by system 105 and/or a module of system 105. Typically, after finishing parsing and recording the hierarchy of the website, system 105 and/or system 105 module may parse the websites contained in the sitemap hierarchy to determine the contents of the webpages. For example, the index page may only contain a welcome screen with links for “Company”, “Products”, and “Support”; the “Company” page may include a link to the “About Us” webpage, a mission statement, and the company's history; the “Products” page may include links to the “Laptops” and “Desktops” webpages, current coupons, a price-match guarantee; etc. This information may be useful, for example, to determine contextual and/or semantic links between items and/or categories, determining whether a webpage needs to be checked with curation, and/or any other aspect where additional information may allow system 105 and/or system 105 module to provide a better guided tour to a user.

In some implementations, the “Parse and record primary hierarchy” 802, “Parse and record sub hierarchy” 804, and “Parse and record data contained within hierarchy” 806 steps may be consolidated into a fewer steps. For example, system 105 and/or system 105 module may perform all three parsings and recordings in a single step where the system 105 and/or system 105 module parse existing levels to traverse (e.g., as determined from the DOM Structure Analyzer, described above) and then systematically parse and record data for each existing level. For example, this algorithm may be represented may the following pseudocode:

set levels_to_be_traversed to n
while levels_to_be_traversed == 0

> Import predefined knowledge from DSA for the particular level of
webpage based on website name
> Use XPath to extract the elements
> Filter and refine the data extracted
> Store the refined data in database
> levels_to_be_traversed − 1

End While

The “Encode hierarchy as sitemap” 808 step typically may be performed by system 105 and/or a module of system 105. Typically, once the primary directories, subdirectories, and data within the hierarchy have been collected and recorded by system 105 and/or system 105 module, a complete sitemap may be created. In some implementations, this sitemap may be created by merging previously created files (e.g., XML files created above), while in other implementations, the sitemap may be created anew using the above-recorded data. For example, system 105 and/or system 105 modules may merge files such as “index.xml”, “company.xml”, “products.xml”, “Support.xml”, etc. to create a sitemap with the website's directories and content and/or content summaries (e.g., headings on the page, first ten words of body text, etc.).

In some implementations, system 105 and/or system 105 module may query one or more data stores that contain the above-recorded information to generate a sitemap. For example, the above-described ‘“[page]”=[page_ID][[parent_ID]]’ format may be translated into XML, HTML, and/or any other hierarchical format to create a sitemap (e.g., resembling a directory tree) for use by system 105 and/or system 105 module to create a guided tour for a user. In some further implementations, a data store may produce a sitemap from a template accessible to the data store, from scratch, and/or using a template for only part of the sitemap (e.g., for the directories but not the individual webpage content under the hierarchy).

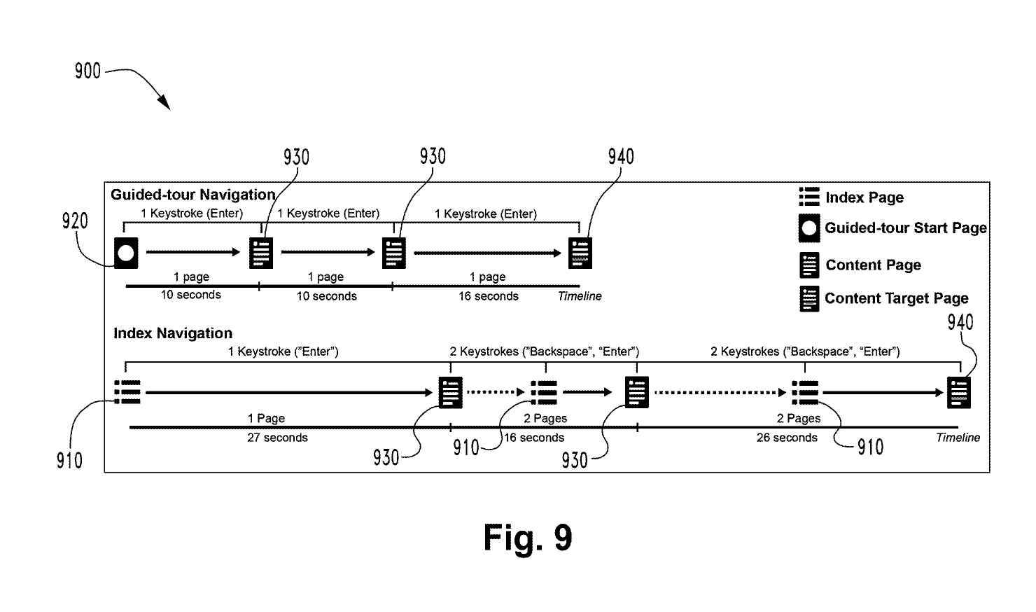

FIG. 9 depicts a sample of a differential timeline comparison for using a guided-tour navigation from the dynamic guided tour system versus a traditional, index navigation system, typically including differential timeline comparison 900, index page 910, guided-tour start page 920, content page 930, and content target page 940. Differential timeline comparison 900 depicts an example use-case by a system 105 user searching for content (which is located on content target page 940) using the disclosed guided-tour navigation approach compared to the traditional approach of starting at a website index, guessing at a webpage, returning to the index to find a new webpage, and then checking that webpage. In the depicted use-case, the guided-tour navigation required only thirty-six seconds to find the target content, whereas it took sixty-nine seconds to find the target content using the traditional, index navigation approach. The guided-tour approach also required three keystrokes to find the target content, whereas the index navigation approach required five keystrokes to find the same target content. Overall, guided-tour navigation may provide a more streamlined navigational experience to a user.

The guided-tour navigation timeline depicts a user arriving at guided-tour start page 920 for a website, parsing the webpage contents (e.g., visually, aurally, tactilely, etc.), pressing enter to proceed to content page 930, parsing content page 930, pressing enter to proceed to another content page 930, parsing content page 930, pressing enter to proceed to another content page 930, and finally parsing content target page 940 to find target content. The total interaction required three keystrokes (pressing enter to advance to the next page in the guided tour), took a total of thirty seconds, and presented three pages to the user.

The index navigation timeline depicts a user arriving at index page 910 for a website, parsing index page 910 contents (e.g., visually, aurally, tactilely, etc.), pressing enter to proceed to content page 930, parsing content page 930, pressing backspace to return to index page 910, rapidly reparsing index page 910, pressing enter to proceed to another content page 930, pressing backspace to return to index page 910, rapidly reparsing index page 910, and finally pressing enter to proceed to content target page 940. The total interaction required five keystrokes (pressing enter three times and backspace two times), took a total of sixty-nine seconds, and presented five pages to the user.

In some implementations, a system may be created to combine the above-two approaches. For example, such a combined approach may provide some benefits to users who may be used to an index approach and/or where a guided-tour approach may not work as fluidly. For example, a user may first be presented with an index from which to select a guided tour, and then the user may be presented with a generated guided tour for that selected topic.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may, in some cases, be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system 105 components in the embodiments described above should not be understood as requiring such separation in all embodiments, and it should be understood that the described program components and systems may typically be integrated together in a single hardware and/or software product or packaged into multiple hardware and/or software products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for reading content on a screen comprising:
receiving a target website;
categorizing content of the target website;
storing the content of the target website to a data store;
generating a sitemap for the target website containing a URL and an ID;
storing the URL and the ID in the data store;
reading the content, the URL, and the ID in the data store as list data;
generating a presentation based on the list data; and
presenting the presentation to a user.

2. The method of claim 1, wherein the presentation is formatted as a guided tour.

3. The method of claim 1, further comprising the step of:
modifying the list data to match curated data on a secondary data store.

4. The method of claim 1, wherein the categorizing step is accomplished by examining a document object model (DOM) structure.

5. The method of claim 1, wherein the presentation is navigable through commands selected from the group consisting of input device shortcuts, vocal commands, and combinations thereof.

6. The method of claim 3, wherein the curated data are supplied by crowdsourcing.

7. The method of claim 2, wherein the guided tour is linearly concatenated.

8. The method of claim 2, wherein:
the URL is a plurality of URLs; and
the ID is a plurality of IDs.

9. A system for reading content on a screen comprising:
a user device;
a computer operable to interact with the user device; and
a network connecting the user device and the computer;
wherein the computer is further operable to:
receive a target website;
categorize content of the target website;
store the content of the target website to a data store;
generate a sitemap for the target website containing a URL and an ID;
store the URL and the ID in the data store;
read the content, the URL, and the ID in the data store as list data;
generate a presentation based on the list data; and
present the presentation to a user.

10. The system of claim 9, wherein:
the URL is a plurality of URLs; and
the ID is a plurality of IDs.

11. The system of claim 9, wherein the computer is the user device.

12. The system of claim 9, wherein the presentation is formatted as a guided tour.

13. The system of claim 9, wherein the computer is further operable to:
modify the list data to match curated data on a secondary data store.

14. The system of claim 9, wherein the categorize step is accomplished by examining a document object model (DOM) structure.

15. The system of claim 9, wherein the presentation is navigable through commands selected from the group consisting of input device shortcuts, vocal commands, and combinations thereof.

16. The system of claim 13, wherein the curated data are supplied by crowdsourcing.

17. The system of claim 12, wherein the guided tour is linearly concatenated.

18. A computer-readable medium having instructions stored thereon, which when executed by one or more computers, causes the one or more computers to:
receive a target website;
categorize content of the target website;
store the content of the target website to a data store;
generate a sitemap for the target website containing a URL and an ID;
store the URL and the ID in the data store;
read the content, the URL, and the ID in the data store as list data;
generate a presentation based on the list data; and
present the presentation to a user.

19. The computer-readable medium of claim 17, wherein the presentation is formatted as a guided tour.

20. The computer-readable medium of claim 17, further causing the one or more computers to:
modify the list data to match curated data on a secondary data store.
